(19) United States
(12) Patent Application Publication
(10) Pub. No.: US 2003/0035763 A1
(43) Pub. Date: Feb. 20, 2003

(54) Process for the purification of organometallic compounds or heteroatomic organic compounds with a catalyst based on iron and manganese supported on zeolites

(75) Inventors: Giorgio Vergani, Monza (IT); Marco Succi, Milano (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES GETTERS S.p.A.

(21) Appl. No.: 10/273,329

(22) Filed: Oct. 17, 2002

Related U.S. Application Data
(63) Continuation of application No. PCT/IT01/00184, filed on Apr. 13, 2001.

(30) Foreign Application Priority Data
Apr. 19, 2000 (IT) MI2000A 000880
Apr. 20, 2000 (IT) MI2000A 000893

(51) Int. Cl. B01D 53/34

(52) U.S. Cl. 422/177

(57) ABSTRACT

A process is described for the purification of organometallic compounds or heteroatomic organic compounds from oxygen, water and from the compounds deriving from the reaction of water and oxygen with the organometallic or heteroatomic compounds whose purification is sought, comprising the operation of contacting the organometallic or heteroatomic compound to be purified, in the liquid state or in form of vapor, pure or in a carrier gas, with a catalyst based on iron and manganese supported on zeolites, and optionally also with one or more gas sorber materials selected among hydrogenated getter alloys and palladium deposited on a porous support.

### CROSS-REFERENCE TO RELATED APPLICATIONS

This application is a continuation of International Application No. PCT/IT01/00184, filed Apr. 13, 2001, which was published in the English language on Oct. 25, 2001 as International Publication No. WO 01/079586 A1 and the disclosure of which is incorporated herein by reference.

### BACKGROUND OF THE INVENTION

The present invention relates to a process for the purification of organometallic compounds or heteroatomic organic compounds with a catalyst based on iron and manganese supported on zeolites.

Organometallic compounds are characterized by the presence of a bond between one metal atom (also arsenic, selenium or tellurium being included among metals) and one carbon atom being part of an organic radical such as, for example, aliphatic or aromatic, saturated or unsaturated hydrocarbon radicals; by extension, with the definition of organometallic compounds also the compounds including metal atoms bound to organic radicals by means of an atom other than carbon, such as for instance the alcoholic radicals (—OR) or of esters (—O—CO—R) are meant.

The heteroatomic organic compounds (also simply defined heteroatomic in the following) are those organic compounds comprising, in addition to carbon and hydrogen, also atoms such as oxygen, nitrogen, halides, sulfur, phosphorus, silicon and boron.

Many of these compounds have been used for a long time in traditional chemical applications. Reagents having very high purity are not generally requested in this field, and their purification is carried out by techniques such as distillation (optionally at reduced pressure, in order to reduce the boiling temperature and therefore the risks of thermal decomposition of the compounds) or recrystallization from solvents.

However, these compounds have been recently used in high technology applications, particularly in the semiconductor industry. In these applications, the organometallic compounds and the heteroatomic compounds are used as reagents in the processes of chemical deposition from the gaseous state (known in the field with the definition “Chemical Vapor Deposition” or with the acronym CVD). In these techniques, a gas flow of one or more organometallic or heteroatomic compounds (or a flow of a carrier gas containing a known concentration thereof) is conveyed into a process chamber; then, inside the chamber the compounds are decomposed or reacted, so that materials containing metal atoms or heteroatoms are formed in situ (generally in the form of thin layers on a substrate). The organometallic or heteroatomic compounds can be already in the gaseous form, but they can also be in the liquid form. In this second case, the gaseous flow of the compound is obtained either by evaporating the compound, in which case the flow is composed only of the compound of interest, or by bubbling a gas in the container for the liquid, in which case the flow contains vapors of the compound in the carrier gas.

The main organometallic gases used in these applications are hafnium tetra-t-butoxide, trimethylaluminum, triethylaluminum, tri-t-butylaluminum, di-i-butylaluminum hydride, trimethoxyaluminum, dimethylaluminum chloride, diethylaluminum ethoxide, dimethylaluminum hydride, trimethylantimony, triethylantimony, tri-i-propylantimony, tris-dimethylamino-antimony, trimethylarsenic, tris-dimethylamino-arsenic, t-butylarsine, phenylarsine, barium bis-tetramethylheptanedionate, bismuth tris-tetramethylheptanedionate, dimethylcadmium, diethylcadmium, iron pentacarbonyl, bis-cyclopentadienyl-iron, iron tris-acetylacetonate, iron tris-tetramethylheptanedionate, trimethylgallium, triethylgallium, tri-i-propylgallium, tri-i-butylgallium, triethoxygallium, trimethylindium, triethylindium, ethyldimethylindium, yttrium tris-tetramethylheptanedionate, lanthanum tris-tetramethylheptanedionate, bis-cyclopentadienyl-magnesium, bis-methylcyclopentadienyl-magnesium, magnesium bis-tetramethylheptanedionate, dimethylmercury, niobium pentaethoxide, niobium tetraethoxydimethylaminoethoxide, dimethylgold acetylacetonate, lead bis-tetramethylheptanedionate, bis-hexafluorocopper acetylacetonate, copper bis-tetramethylheptanedionate, scandium tris-tetramethylheptanedionate, dimethylselenium, diethylselenium, tetramethyltin, tetraethyltin, tin tetra-t-butoxide, strontium bis-tetramethylheptanedionate, tantalum pentaoxide, tantalum tetraethoxydimethylaminoethoxide, tantalum tetraethoxytetramethylheptanedionate, tantalum tetramethoxytetramethylheptane-dionate, tantalum tetra-i-propoxytetramethylheptanedionate, tantalum tri-diethyl-amido-t-butylimide, dimethyltellurium, diethyltellurium, di-i-propyltellurium, titanium bis-i-propoxy-bis-tetramethylheptanedionate, titanium bis-i-propoxy-bis-dimethylaminoethoxide, titanium bis-ethoxy-bis-dimethylamino-ethoxide, titanium tetradimethylamide, titanium tetradiethylamide, titanium tetra-t-butoxide, titanium tetra-i-propoxide, vanadyl i-propoxide, dimethylzinc, diethylzinc, zinc bistetramethylheptanedionate, zinc bis-acetylacetonate, zirconium tetra-t-butoxide, zirconium tetratetramethylheptanedionate and zirconium tri-i-propoxy-tetramethylheptanedionate.

The principal heteroatomic compounds used in these applications are trimethylborane, asymmetric dimethylhydrazine (that is, wherein both methyl groups are bound to the same nitrogen atom), t-butylamine, phenylhydrazine, trimethylphosphorus, t-butylphosphine and tbutylmercaptane.

Some typical examples of application of these methods are the production of the semiconductors of type III-V, such as GaAs or InP, or of type II-VI such as ZnSe; the use for p doping (for instance with boron) or n doping (for instance with phosphorus) of traditional silicon-based semiconductor devices; the production of materials having a high dielectric constant (for example compounds such as PbZrₓTi1-ₓO₃) used in ferroelectric memories; or the production of materials having a low dielectric constant (such as SiO₂) for insulating electric contacts in semiconductor devices.

For these applications reagents having an extremely high purity are required, with levels of the order of 10⁻¹, 10⁻² ppm, whereas the traditional chemical techniques do not allow to obtain levels of impurities lower than about ten ppm. Further, even in the case that organometallic or heteroatomic compounds of very high purity are produced, the storage is source of contamination due to gas release from the container walls, which anyway makes necessary to use a purifier immediately before the application (so-called “point-of-use” purifiers).

U.S. Pat. No. 5,470,555 describes the removal from organometallic compounds of oxygen gas which is present as an impurity, by using of a catalyst formed of copper or nickel metals, or the relevant oxides activated by reduction with hydrogen, deposited on a support such as alumina, silica or silicates. According to the patent, by this method the removal of oxygen gas from a flow of the organometallic compound can be obtained, down to values of 10⁻² ppm.

However, oxygen is not the only impurity that has to be removed from the organometallic or heteroatomic compounds. Other harmful impurities in the CVD processes are for example water and, particularly, the species deriving from the alteration of the same organometallic or heteroatomic compound, following to undesired reactions generally with water or oxygen. For instance, in the case of a generic organometallic compound MRₙ, wherein M represents the metal, R an organic radical and n the valence of the metal M, contamination from MRₙ₋ₓ(—OR)ₓ species can occur, wherein x is an integer varying between 1 and n. These oxygenated species are harmful in the CVD processes because they introduce oxygen atoms into the material being formed, thus sensibly altering the electric properties thereof.

### BRIEF SUMMARY OF THE INVENTION

Object of the present invention is providing a process for the purification of organometallic compounds or heteroatomic organic compounds from oxygen, water and from the compounds derived from the reaction of water and oxygen with organometallic or heteroatomic compounds whose purification is sought.

This object is obtained according to the present invention with a process wherein the organometallic or heteroatomic compound to be purified is contacted with a catalyst based on iron and manganese deposited on zeolites. The purification can be carried out on the organometallic or heteroatomic compound either in the liquid or in the vapor state.

It is also possible to use, in addition to the iron- and manganese-based catalyst, other impurity-sorbing materials, such as a hydrogenated getter alloy or a palladium-based catalyst.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 shows a cutaway view of a purifier by which it is possible to put into practice a first embodiment of the process of the invention;

FIG. 2 shows a cutaway view of a purifier by which it is possible to put into practice a second embodiment of the process of the invention.

### DETAILED DESCRIPTION OF THE INVENTION

In one embodiment thereof, the process of the invention consists in contacting the catalyst based on iron and manganese deposited on zeolites with the compound to be purified in the liquid state. This can be carried out simply by introducing the catalyst into the container of the liquid compound, from which the same will be evaporated by heating or with a carrier gas.

However, in a preferred embodiment the purification is carried out by contacting the catalyst based on iron and manganese with vapors, pure or in a carrier gas, of the organometallic or heteroatomic compound. In the following, the invention will be described with particular reference to the purification at the vapor state, since this is the condition most commonly used in the industry.

The sum of the metals generally forms about 10 to 90% of the total catalyst weight. The ratio between iron and manganese can vary between about 7:1 and 1:1 and is preferably about 2:1.

A catalyst suitable for the purpose of the invention is sold by the Japanese company Nissan Girdler Catalyst Co. Ltd. for the purification of inert gases such as helium, argon or nitrogen. This product contains iron and manganese in a weight ratio of about 1.8:1.

When it is desired to have a different ratio between the two materials, the catalyst can be produced by depositing iron and manganese metals in the desired ratio on zeolites. The deposit of metals on zeolites is generally formed by techniques of coprecipitation from a solution wherein soluble compounds (also indicated in the following as precursors) of iron and manganese have been solved, and wherein the zeolites which will form the catalyst support are provided. The starting solvent and the precursors can be selected in a wide range of possibilities, with the only condition that the precursors are soluble in the selected solvent. For example, it is possible to use organic solvents such as alcohols and esters with precursor wherein the metals are complexed with an organic ligand: complexes of metals with acetylacetone are typically used in this case. Preferably, though, a water solution is used for operation. In this case, the precursors employed are soluble salts of the metals, such as for instance chlorides, nitrates or acetates. The precipitation of the compounds forming the first deposit on the zeolites is generally carried out by increasing the pH of the solution; it is thus obtained a first deposit formed of the metal compounds, generally oxides or hydroxides or more generally intermediate species of the oxy-hydroxides type. Once this first deposit has been obtained, the solution is centrifuged or filtered and the wet powders are first dried and then treated at high temperature for the conversion of the compounds of iron and manganese to metals. The reduction of the oxy-hydroxides to the metal form occurs with a two-steps thermal treatment, wherein in the first step a flow of hydrogen having a temperature higher than 200° C. is passed on the intermediate product for a time of at least 4 hours; in the second step, which immediately follows the first one, a flow of purified argon at a temperature of at least 200° C. is passed on the reduced intermediate product for at least 4 hours.

The support of the catalyst is generally in the form of pellets or small cylinders, having size between 1 and 3 mm.

The range of the useful temperatures for the purification of organometallic or heteroatomic compounds with the catalyst based on iron and manganese is between about −20° C. and 100° C.; at lower temperatures the removal of oxygen is limited, whereas at temperatures higher than about 100° C. decomposition reactions of the gas to be purified could occur. The range of the preferred temperatures is within room temperature and about 50° C.

The flow of the gas to be purified can vary between about 0.1 and 20 slpm (liters of gas, measured in standard conditions, per minute) at absolute pressures preferably comprised between about 1 and 10 bars.

This flow can be formed only of the vapors of the compound to be purified, or of said vapors in a flow of a carrier gas. The carrier gas can be any gas interfering neither with the catalyst based on iron and manganese (or with the other possibly used gas sorbing materials) nor with the deposition process wherein the organometallic or heteroatomic compound is used. Argon, nitrogen or even hydrogen are commonly used.

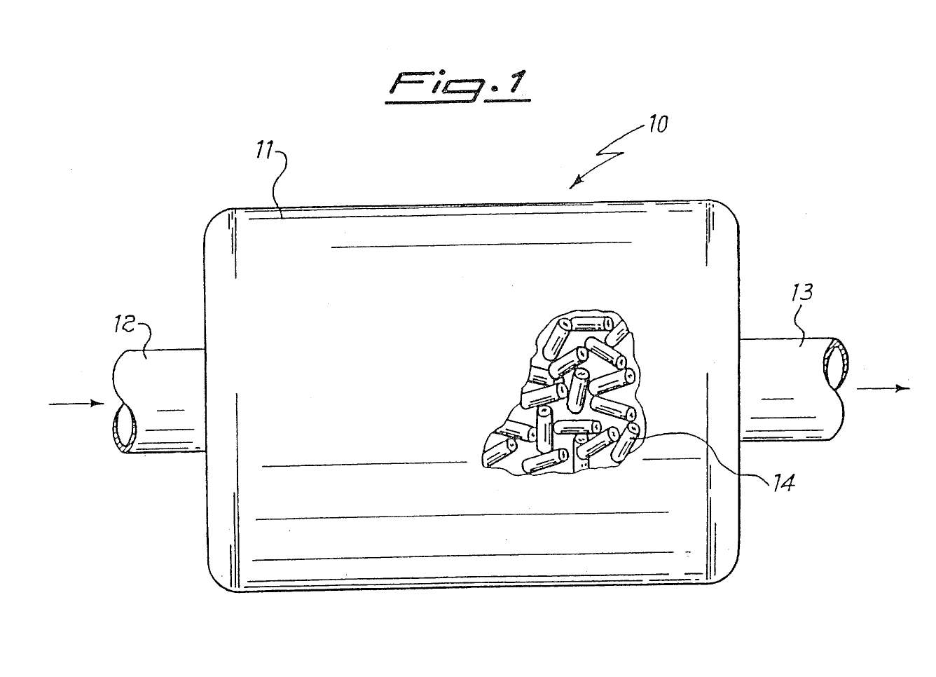

FIG. 1 shows a cutaway view of a possible purifier to be used in the first embodiment of the process according to the invention. The purifier 10 is formed of a body 11, generally cylindrical; at the two ends of body 11 there are provided a piping 12 for the inlet of the gas into the purifier, and a piping 13 for the gas outlet. The catalyst 14 based on iron and manganese on zeolites (the type with the support of cylindrical shape is exemplified) is contained inside body 11. The inlet 12 and the outlet 13 of the gas are preferably provided with standard connections of the VCR type, known in the field (not shown in the figure) for connection with the gas lines upstream and downstream of the purifier. The purifier body can be made with various metal materials; the preferred material for this purpose is steel AISI 316. The internal surfaces of the purifier body, which are in contact with the gas, are preferably electropolished until a surface roughness lower than about 0.5 μm is obtained. In order to prevent traces of the catalyst powder from being carried downstream of the purifier by the outlet gas flow, inside the purifier body at outlet 13 can be arranged means for retaining the particulate, such as nets or porous septa, generally metallic, having size of the “gaps” or of the pores suitable for retaining particles without causing an excessive pressure drop in the gas flow; the size of these openings can generally vary between about 10 and 0.003 μm.

The gas flow to be purified can be contacted, not only with the catalyst based on iron and manganese, but also with at least one additional material, selected among a hydrogenated getter alloy and a catalyst based on palladium deposited on a porous support, or both.

The use of hydrogenated getter alloys for the purification of gases in the microelectronic field is known by patent EP-B-470936, but restricted to the purification of simple hydrides, such as SiH₄, PH₃ and AsH₃.

The getter alloys useful for the invention are the alloys based on titanium or zirconium with one or more elements selected among the transition metals and aluminum, and mixtures of one or more of these alloys with titanium and/or zirconium. In particular, useful for the invention are the alloys ZrM₂, wherein M is one or more among transition metals Cr, Mn, Fe, Co or Ni, described in patent U.S. Pat. No. 5,180,568; the alloys Zr—V—Fe described in patent U.S. Pat. No. 4,312,669 and particularly the alloy having weight percent composition Zr 70%—V 24.6%—Fe 5.4% manufactured and sold by the Applicant under the name St 707; the alloys Zr—Co-A, wherein A means any element selected among yttrium, lanthanum, Rare Earths or mixtures of these elements, described in patent U.S. Pat. No. 5,961,750; the alloys Ti—Ni; and the alloys Ti—V—Mn described in patent U.S. Pat. No. 4,457,891.

The loading with hydrogen of the above mentioned alloys is carried out at a hydrogen pressure lower than 10 bars, and preferably higher than the atmospheric pressure, at temperatures comprised between room temperature and about 400° C. Greater details on the method of loading the getter alloys with hydrogen can be found in the above mentioned patent EP-B-470936. The optimal temperature range for use of the hydrogenated getter alloys in this application is comprised between room temperature and about 100° C.

Preferably, the catalyst based on palladium on a porous support contains 0.3 to 4% of palladium with respect to the total catalyst weight. At lower values of palladium content, the activity of impurity removal is limited, whereas palladium quantities higher than 4% by weight bring about a great increase of the catalyst cost without notable increases of the purification yield. The optimal temperature range for use of this material is included between about −20° and 100° C., and preferably between about room temperature and 50° C.

The support for palladium-based catalyst may be any porous material normally used in the catalysis field, such as, e.g., ceramics, molecular sieves, zeolites, porous glass and so on. Catalysts based on palladium on a porous support are available on the market, and are sold for the catalysis of chemical reactions (for example, hydrogenation reactions) from the companies Süd Chemie, Degussa and Engelhard. Alternatively, the catalyst can be produced by impregnation in solution of a porous support with a quantity of a palladium salt or complex, for example palladium chloride, PdCl₂, calculated on the basis of the desired quantity of palladium in the final catalyst; drying of the so impregnated porous support; decomposition (for example, thermal) of the precursor; optional calcination, for example at temperatures of about 400-500° C., of the product so obtained.

The additional material (or the additional materials) can be positioned indifferently upstream or downstream of the catalyst based on iron and manganese along the direction of the gas flow. It is also possible, when both the cited additional materials are used, that one of them is upstream ad the other one downstream of the catalyst based on iron and manganese.

The additional material (or the additional materials) can be provided in a separated body, connected to body 11 of the purifier containing the catalyst based on iron and manganese by means of pipings and fittings, for instance of the above mentioned VCR type. Also this second body will be preferably made of the materials and with the finishing level of the surfaces as described for body 11.

Preferably, the additional material (or the additional materials) are arranged in the same purifier body wherein the catalyst based on iron and manganese is provided. In this case, the different materials can be mixed, but preferably they are separated in the purifier body.

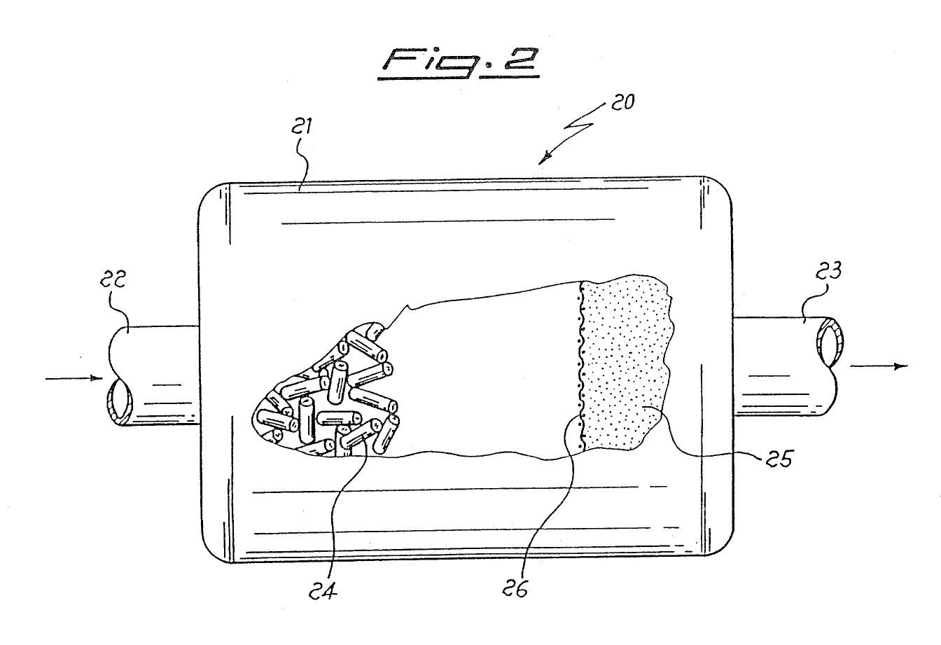

FIG. 2 shows a cutaway view of a possible purifier containing more than one material (the case of two materials is exemplified); in particular, it shows a purifier made according to the preferred mode wherein the different materials are kept separated inside the purifier body. The purifier 20 is formed of a body 21, a gas inlet 22 and a gas outlet 23; the catalyst based on iron and manganese 24 is arranged on the side of inlet 22 inside body 21, and, on the side of the outlet 23, is arranged a material 25 selected between a hydrogenated getter alloy or a catalyst based on palladium on a porous support; preferably, a mechanical member 26 which is easily permeable to gases, such as a metal net, is arranged between the two materials in order to help maintaining the separation and the original geometrical arrangement of the materials.

In the case that two different materials are present at the same time in the same body (the situation exemplified in FIG. 2), the purifier must be kept at a temperature compatible with the working temperature of all the present materials, and consequently preferably between room temperature and about 50° C.

Finally, it is also possible to add to the various cited materials also a water chemical sorber, for example calcium oxide or boron oxide, this latter prepared according to the teachings of patent application EP-A-960647 in the Applicant's name.

The invention will be further illustrated in the following example. This example does not limit the scope of the invention and is useful for illustrating a possible embodiment intended to teach those skilled in the art how to put the invention into practice and to represent the way that is considered the best for carrying out the invention.

### EXAMPLE 1

A purifier of the type shown in FIG. 1 is made. The purifier has a body made of steel AISI 316 and an internal volume of about 30 cm³. The catalyst, formed of small zeolite cylinders (total volume 15 cm³) on which iron and manganese are deposited in the measure of 56% and 31% respectively with respect to the total catalyst weight, is introduced into the purifier. The purifier is then connected, by means of VCR connections, upstream to a nitrogen cylinder containing 10 ppm by volume (ppmv) of water and 100 ppmv of oxygen, and downstream to a mass spectrometer of the APIMS type (atmospheric pressure ionization mass spectrometer) mod. TOF 2000 of the company Sensar, that has a sensing threshold of 10⁻⁴ ppmv both for water and for oxygen. The test is carried out in nitrogen instead of in a flow of vapor of an organometallic compound, because the analyzing instrument used (APIMS) has a reduced sensibility in the vapors of these compounds, such that a test with an organometallic compound would not enable to obtain significant results. The gas to be purified is passed at 5 bars in the purifier maintained at room temperature, with a flow of 0.1 slpm. At the beginning of the test the quantity of water and oxygen in the gas outlet from the purifier is under the analyzer sensibility threshold, indicating the functionality of the catalysts based on iron and manganese in the removal of these species. The test is continued until the analyzer senses in the gas output from the purifier a quantity of contaminant of 10⁻³ ppmv; this contamination value of the output gas is adopted as indicator of the purifier depletion. From the knowledge of the test data, it is proved that the purifier has a capacity of 20 l/l (liters of the gas measured in standard conditions per liter of the iron- and manganese-based catalyst) both for oxygen and for water.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A process for the purification of organometallic compounds or heteroatomic organic compounds from oxygen, water and from the compounds derived from the reaction of water and oxygen with the compounds whose purification is sought, comprising the operation of contacting the organometallic or heteroatomic organic compound to be purified with a catalyst formed of iron and manganese metals supported on zeolites.

2. A process according to claim 1 wherein the catalyst based on iron and manganese is contacted with the organometallic or heteroatomic organic compound in the form of vapor, pure or in a carrier gas.

3. A process according to claim 1 wherein the sum of the weights of iron and manganese is between 10% and 90% of the total catalyst weight.

4. A process according to claim 1 wherein the weight ratio between iron and manganese is between 7:1 and 1:1.

5. A process according to claim 4 wherein said ratio is about 2:1.

6. A process according to claim 2 wherein said operation is carried out at a temperature between about −20 and 100° C.

7. A process according to claim 6 wherein said operation is carried out at a temperature between room temperature and 50° C.

8. A process according to claim 2 wherein said operation is carried out with a flow of the gas to be purified between about 0.1 and 20 slpm, at absolute pressures comprised between about 1 and 10 bars.

9. A process according to claim 1 wherein the organometallic compound is selected among hafnium tetra-t-butoxide, trimethylaluminum, triethylaluminum, tri-t-butylaluminum, di-i-butylaluminum hydride, trimethoxyaluminum, dimethylaluminum chloride, diethylaluminum ethoxide, dimethylaluminum hydride, trimethylantimony, triethylantimony, tri-i-propylantimony, tris-dimethylamino-antimony, trimethylarsenic, tris-dimethylamino-arsenic, t-butylarsine, phenylarsine, barium bis-tetramethylheptanedionate, bismuth tris-tetramethylheptanedionate, dimethylcadmium, diethylcadmium, iron pentacarbonyl, bis-cyclopentadienyl-iron, iron tris-acetylacetonate, iron tris-tetramethylheptanedionate, trimethylgallium, triethylgallium, tri-i-propylgallium, tri-i-butylgallium, triethoxygallium, trimethylindium, triethylindium, ethyldimethylindium, yttrium tris-tetramethylheptanedionate, lanthanum tris-tetramethylheptanedionate, bis-cyclopentadienyl-magnesium, bis-methylcyclo-pentadienyl-magnesium, magnesium bis-tetramethylheptanedionate, dimethyl-mercury, niobium pentaethoxide, niobium tetraethoxydimethylaminoethoxide, dimethylgold acetylacetonate, lead bis-tetramethylheptanedionate, bis-hexafluorocopper acetylacetonate, copper bistetramethylheptanedionate, scandium tris-tetramethylheptanedionate, dimethylselenium, diethylselenium, tetramethyltin, tetraethyltin, tin tetra-t-butoxide, strontium bis-tetramethyl-heptanedionate, tantalum pentaoxide, tantalum tetraethoxydimethylaminoethoxi-de, tantalum tetraethoxytetramethyl-heptanedionate, tantalum tetramethoxy-tetramethylheptanedionate, tantalum tetra-i-propoxytetramethylheptanedionate, tantalum tri-diethylamido-t-butylimide, dimethyltellurium, diethyltellurium, di-i-propyl-tellurium, titanium bis-i-propoxy-bis-tetrarnethylheptanedionate, titanium bis-i-propoxy-bis-dimethylaminoethoxide, titanium bis-ethoxybis-dimethylaminoethoxide, titanium tetradimethylamide, titanium tetradiethylamide, titanium tetrat-butoxide, titanium tetra-i-propoxide, vanadyl i-propoxide, dimethylzinc, diethylzinc, zinc bistetramethylhcptanedionate, zinc bis-acetylace-tonate, zirconium tetra-t-butoxide, zirconium tetratetramethylhcptanedionate and zirconium tri-i-propoxy-tetramethylheptanedionate.

10. A process according to claim 1 wherein the heteroatomic organic compound is selected among trimethylborane, asymmetric dimethylhydrazine, t-butylamine, phenylhydrazine, trimethylphosphorus, t-butylphosphine and t-butylmercaptan.

11. A process according to claim 1 further comprising the operation of contacting the organometallic or organic heteroatomic compound to be purified with at least one second material selected between a hydrogenated getter alloy and a catalyst based on palladium supported on a porous support.

12. A process according to claim 11 wherein the organometallic or heteroatomic compound is in the form of vapor, pure or in a carrier gas.

13. A process according to claim 11 wherein the second material is a hydrogenated getter alloy selected among the alloys based on titanium and/or zirconium with one or more elements selected among transition metals and aluminum, and mixtures among one or more of these alloys with titanium and/or zirconium.

14. A process according to claim 13 wherein the getter alloy is selected among ZrM₂ alloys, wherein M is one or more among transition metals Cr, Mn, Fe, Co or Ni; the alloys Zr—V—Fe and particularly the alloy having weight percent composition Zr 70%—V 24.6%—Fe 5.4%; the alloys Zr—Co-A, wherein A means any element selected among yttrium, lanthanum, Rare Earths or mixtures of these elements; the alloys Ti—Ni; and the alloys Ti—V—Mn.

15. A process according to claim 12 wherein the contact between the vapor to be purified and the hydrogenated getter alloy occurs at a temperature between room temperature and about 100° C.

16. A process according to claim 11 wherein the second material is a catalyst based on palladium on a porous support with a palladium content of 0.3% to 4% by weight.

17. A process according to claim 12 wherein the contact between the gas to be purified and the supported palladium occurs at a temperature between about −20 and 100° C.

18. A process according to claim 17 wherein said contact occurs at a temperature between room temperature and 50° C.

19. A process according to claim 1 further comprising the operation of contacting the organometallic or heteroatomic organic compound to be purified, in the form of vapor, pure or in a carrier gas, with a chemical water sorber.
